(19) United States
(12) Patent Application Publication
(10) Pub. No.: US 2023/0348120 A1
(43) Pub. Date: Nov. 2, 2023

(54) SYSTEM AND METHOD FOR IDENTIFYING TRASH WITHIN A PREDETERMINED GEOGRAPHIC BOUNDARY USING UNMANNED AERIAL VEHICLES

(71) Applicant: Brian Panahi Johnson, San Francisco, CA (US)

(72) Inventor: Brian Panahi Johnson, San Francisco, CA (US)

(21) Appl. No.: 18/349,871

(22) Filed: Jul. 10, 2023

(51) Int. Cl. B64U 20/80; G06V 10/82

(52) U.S. Cl. CPC B64U 20/80; G06V 10/82; B64U 2101/31

(57) ABSTRACT

The present invention provides a system and method for identifying trash within a predetermined geographic boundary using Unmanned Aerial Vehicles (UAVs). The system comprises a UAV equipped with a camera, a wireless transceiver, and a first processor. The UAV communicates with a controller via a wireless network. The controller, which can be cloud-based or located on a computer connected to the wireless network, is configured to process image data captured by the camera using a neural network. The neural network helps to identify and geolocate trash within the images. The controller is further configured to route the UAV according to a preprogrammed flight path, plot the locations of any detected trash onto a map, and generate a report that can be made accessible to subscribers.

### FIELD OF THE INVENTION

The present invention relates to a system and method for identifying trash within a predetermined boundary using Unmanned Aerial Vehicles (UAVs).

### BACKGROUND OF THE INVENTION

Cities face challenges in determining necessary infrastructure, maintenance, and upkeep tasks. Currently, cities rely on citizen reporting and intermittent patrolling by city employees and vendors to identify these needs. However, this approach is time-consuming and inconsistent due to factors such as accessibility and traffic. This inconsistency can lead to disparities in the quality of life between various areas within a city, which is detrimental to residents. Some cities also employ pre-planned trash pickup schedules, but these can be inefficient when areas scheduled for cleaning do not have enough trash to justify the resources allocated.

### SUMMARY OF THE INVENTION

The present invention provides a system and method for identifying trash within a predetermined geographic boundary. The system includes a UAV that communicates with a controller via a wireless network. The UAV is equipped with a camera, a wireless transceiver, and a first processor for processing flight instructions. The controller, which can be cloud-based or located on a computer connected to the wireless network, is configured to process image data captured by the camera using a neural network for trash detection and geographic location determination. The controller can route the UAV according to a preprogrammed flight path and plot the locations of any detected trash onto a map. The system generates a report that can be made accessible to subscribers.

### BRIEF DESCRIPTION OF THE DRAWINGS

FIG. 1 shows a UAV capable of capturing images of streets, sidewalks, or other surfaces near or on the ground.

FIG. 2 shows image, position, rotation, altitude, latitude and longitude, and flight path data transmitting from UAV to a controller, wherein the controller can store that data on some storage media.

FIG. 3 shows one example of a neural network configured to detect trash piles within aerial images, and identify the position within an image.

FIG. 4 shows a processor which is programmed to geolocate detections from FIG. 4, computing the absolute position of each trash pile by orienting the detections in global space given rotation, altitude, latitude, longitude of the UAV camera as well as the location of detections within the image. These global locations and images transmitted to a garbage collector shown in FIG. 5.

FIG. 5 shows a garbage collector routed to a garbage's global position and shown detailed trash pile information and its derivatives identified by a neural network shown in FIG. 3.

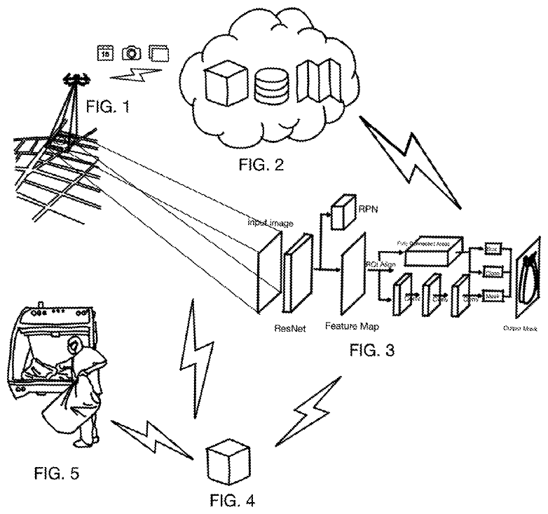

### DETAILED DESCRIPTION OF THE INVENTION

The present invention provides a system and method for identifying trash within a predetermined geographic boundary using UAVs. The system comprises a UAV equipped with a camera, a wireless transceiver, and a first processor. The UAV communicates with a controller via a wireless network. The controller, which can be cloud-based or located on a computer connected to the wireless network, is configured to process image data captured by the camera using a neural network. The neural network helps to identify and geolocate trash within the images.

The controller is further configured to route the UAV according to a preprogrammed flight path. The controller processes a map within which a predetermined geographic boundary can be specified by a user. The map can be uploaded or generated in real-time using the location of the UAV, which is equipped with a GPS sensor. The controller plots the locations of any detected trash onto the map and generates a report that can be made accessible to subscribers.

1: A system for identifying trash within a predetermined geographic boundary, comprising:
a) an Unmanned Aerial Vehicle (UAV) equipped with a camera;
b) a wireless network facilitating communication between the UAV and a controller;
c) a controller configured to process images from the camera to identify trash and plot the location of the identified trash onto a map.

2: The system of claim 1, further comprising a neural network configured to process images from the camera to identify and geolocate trash.

3: The system of claim 2, wherein the controller is configured to route the UAV according to a preprogrammed flight path.

4: The system of claim 3, wherein the controller is further configured to generate a report based on the identified and geolocated trash, and make the report accessible to a subscriber.

5: The system of claim 4, wherein the predetermined geographic boundary is user-defined.

6: The system of claim 5, wherein the controller resides in a cloud and is accessible over the wireless network.

7: The system of claim 6, wherein the UAV is equipped with a GPS sensor to provide real-time location data.

8: A method for identifying trash within a predetermined geographic boundary, comprising the steps of:
a) capturing images using a UAV;
b) transmitting the images to a controller via a wireless network;
c) processing the images using a neural network to identify trash;
d) geolocating the identified trash;
e) plotting the location of the identified trash onto a map;
f) generating a report based on the identified and geolocated trash;
g) making the report accessible to a subscriber.
